(19) United States
(12) Patent Application Publication
(10) Pub. No.: US 2011/0289730 A1
(43) Pub. Date: Dec. 1, 2011

(54) DOOR HANDLE ASSEMBLY FOR A MOTOR VEHICLE

(76) Inventors: Bernd Gerdes, Essen (DE); Bernd Reifenberg, Essen (DE); Witold Joschko, Kempen (DE); Klaus-Dieter Kulik, Velbert (DE); Stephan Riefers, Krefeld (DE)

(21) Appl. No.: 13/133,139

(22) PCT Filed: Nov. 10, 2009
(86) PCT No.: PCT/EP09/64931

§ 371 Date: Aug. 12, 2011

(30) Foreign Application Priority Data
Dec. 11, 2008 (DE) 10 2008 054 526.0

(51) Int. Cl. E05B 1/00

(52) U.S. Cl. 16/412

(57) ABSTRACT

The invention relates to a door handle arrangement for a motor vehicle having a handle component that has a handle (1) and at least one fastener section (3, 4) connected to the handle. The fastener section can be coupled to a fastener receptacle arranged in a door of the motor vehicle. A first conducive coil, the winding of which surrounds a hub (16) arranged in the handle component, is arranged in the handle component, wherein the hub extends at least partially in the listener section (3, 4) of the handle component. In the region of the fastener receptacle on the vehicle side, a second conductive coil is designed such that the hub arranged in the handle component (16) extends through the second coil upon coupling of the fastener section to the fastener receptacle.

The invention relates to a door handle assembly for a motor vehicle.

The invention relates particularly to a door handle assembly by which an outside handle component, operable by the user, is connected without wires to an inside handle component on the vehicle side in order to provide electronic functions.

Door handles with functional electronic components for motor vehicles are known. The electronic components in the door handle serve mostly for the sensory detection of a user's access or for detection of a user's approach.

When the outside part of the handle, which is accessible to the user, is installed in the motor vehicle with a component on the vehicle side, consisting of the inside part of the handle or mount, the electronic components are connected to the complete handle assembly. Between the accessible external component part, particularly the handle that will be operated by the user, and the mount on the vehicle side there is usually an outside door panel; fastener elements coupled to the handle are passed through this plate, thereby enabling a coupling of the outside and the inside handle component.

Wires connected to the electronic components arranged in the handle are arrayed in or alongside the fastener elements in order to be coupled to corresponding connectors behind the door panel on the inside of the door. Sensors on the handle side, antennas or other elements can then be activated or selected by means of the signal connection. Such connections may be plug connections or clamped connections as well as solder connections.

To ensure safe and simple installation and also to lessen proneness to malfunctions of such door handles, it is desirable to keep the coupling of the electronics on the inner and outer side of the door as simple as possible.

The basic task of the invention is to make available a simple signal connection between an outside handle component and an inside handle component on the vehicle side which simplifies the installation and improves the reliable activation of electronic components in the handle.

The task is solved in accordance with the invention through a door handle assembly with the features of patent claim 1.

The door assembly for a motor vehicle in accordance with the invention features in external handle component which has a handle and at least one fastener section connected to the handle. The fastener section can be mechanically coupled on the vehicle side to a fastener receptacle (mount receptacle) of a handle carrier arranged in a door of the motor vehicle.

The handle is that part of the door handle assembly which is installed in a readily accessible manner on the outside of the vehicle in order to allow a user to gain access. The fastener section connected to the handle is coupled to a fastener receptacle on the vehicle side in or at the mount of the handle assembly. The fastener section can be arrayed in this receptacle in, for example, a pivoting or movable manner. In addition, between the fastener section and the mount section on the vehicle side, the mechanical coupling can be designed in such a way as to allow, by means of the fastener section and some mechanical interaction, closing functions or other mechanical functions when the handle is operated.

In accordance with the invention the handle component is designed to contain a first conductive coil, the winding of which surrounds a coil core arrayed in the handle component. The coil core extends at least partially in the fastener section of the handle component. The handle is regularly designed to be elongated in order to be accessible to the user from below, from above or from behind. The fastener is often designed at an angle to the handle in order to extend into the inside of the motor vehicle door through the door panel. The coil core extends at feast partially in the fastener and can at intervals reach into the body of the handle. For this purpose, the coil core may feature an appropriately curved or angled form; it may, however, also be designed as a straight coil core that extends only with a terminal section into the region of the fastener or the handle.

In the area of the fastener receptacle a second conductive coil is arrayed on the vehicle side. The conductive coil on the vehicle side is designed in such way that, when the door handle assembly is installed, that is, when the handle component with its fastener section is coupled to the fastener receptacle on the vehicle, the coil core located in the fastener section is passed through the second conductive coil. In accordance with the invention, therefore, the coil core in its installed state extends both through the coil in the handle component and into the coil arranged on the vehicle side. A coupling is produced between both electric coils via the coil core, which penetrates both coils, by means of an open magnetic field. It is essential in accordance with the invention that no electrically conductive connection needs to be turned on, but rather that a purely magnetic coupling ensues. Thus the fastener section, without regard to mechanical load on conductive connections, can be coupled movably to the fastener receptacle, so that when, for example, the handle or the handle component is pivoted, the for rite coil core is moved or tilted but nonetheless continues to penetrate the coil on the vehicle side. Thereby a movable and stable signal connection is established.

In accordance with the invention a coupling is established through the field lines; these are generated in the coil core by the activation of a coil and established by electrical cur cent through the coil on the vehicle side or the handle side, but they also penetrate the other corresponding coil. Sensory electronics and other electronic components can be coupled to the coil in the handle component. A prompt or activation of the electronic components on the handle side can be undertaken on the vehicle side by activating the second conductive coil.

Consequently, in accordance with the invention an open magnetic field is used in order to establish a signal connection of the handle component and the fastener receptacle on the vehicle side with the second conductive coil and to transmit information.

In a further development of the invention the first conductive coil, which is arrayed in the handle component, is designed as a conductor path on a circuit board, with an opening for the passage of the coil core designed in the circuit board.

Along with the coil, further components for sensory detection, such as proximity sensors, can be arrayed in the circuit board. Array of the conductive coil as a conductor path on a circuit board ensures a reproducible coil design and especially economical manufacturing as part of the manufacture of the entire circuit board.

The coil core is preferably designed as a ferrite coil core.

Ferrite coil cores are particularly suitable as a coupling element for the magnetic field lines between both coils. The fact that ferrites are generally a brittle material is not to be viewed critically for the door handle in accordance with the invention because the coil core is securely contained in the handle component. Mechanical loads are absorbed by the fastener section or the handle, while the coil core is exposed to no or only extremely minimal mechanical loads.

In a further development of the invention at least two fastener-sections are designed in the handle component, the coil core being arrayed in at least one of these fastener sections.

If, for example, a front fastener section and a rear fastener section are arrayed In the handle, one of the fastener sections can then serve to ensure a pivotal connection and a fixture on the vehicle. The other fastener section can be designed for the mechanical coupling to a door lock. In which of the fastener sections the coil core is to be arranged depends on the possible arrangements of the coils in the handle and on the vehicle side, but in principle it is possible to arrange the coil cores in either of the fastener sections.

The first coil in the handle component, along with the coil core, is preferably injection-molded with synthetic material and encapsulated in order to protect them from any environmental impacts. A protected and encapsulated arrangement of this kind is resistant to environmental impacts such as rain, humidity and frost.

An evaluation circuit or an activation circuit is preferably coupled to the second conductive coil on the vehicle side. This circuit is responsible for the activation of the second coil to produce or prompt magnetic field lines which penetrate the coil core. For this purpose, an inverter can be arranged especially on the vehicle side to convert the direct voltage into alternating voltage to generate field lines.

In a further development of the invention electronic sensor components are arrayed in the handle component; these are, in turn, electrically coupled to the winding of the first coil. The evaluation circuit on the vehicle side can identify a condition detected by the sensor components. A capacitance sensor arrayed in the handle component can be coupled, for example, to the coil via a rectifier diode; the coil, in turn, is coupled through the coil core to the second coil on the vehicle side. On the basis of an alternating load in the circuitry of the first coil, a sensor prompting can then be identified and evaluated through detection on the part of the second coil. A load modulation on the part of the handle component thus serves as a basis for evaluating the sensor signals on the vehicle side without the need for an electrical conductive connection. Load modulation may occur through the influence of a capacitance sensor at the approach of a user.

In another design example LEDs, which are coupled to the winding of the first coil, are arrayed in the handle section. These LEDs can be supplied with energy by the first coil; for that purpose, however, the LEDs require sufficient operating voltage. For this purpose it is possible to energize the winding of the second coil, in a second operative mode of the device, with increased voltage that is fed to the winding of the second coil with an inverter and transmitted to the winding of the first coil. The 12-volt power supply of an automobile, for example, could be used for Increased voltage; the said power supply can be connected to the Inverter of the winding of the second coil by activating a switch.

Increased voltage on the vehicle side results in increased voltage on the handle side, If the LEDs are coupled to the first coil, flashing of the LEDs can be activated by means of increased voltage. Depending on the voltage a rectifier assembly, e.g. a diode, must be inserted before the LEDs, but a diode is a standard feature anyhow in a sensor assembly. A flashing function in the handle can be produced merely by increased voltage generated from, the vehicle side without the need of wiring. Even several LEDs can be connected in series, allowing different handle positions to be illuminated.

Alternatively, a comparator circuit may be installed, supplying the LEDs with voltage when the voltage induced in the first coil surpasses a given minimal voltage; this indicates a change to the second operative mode, i.e. the illumination mode. Thus a wireless illumination function can be realized in the door handle with minimal expenditure of switches.

The invention will now be explained in more detail with the aid of the accompanying illustrations.

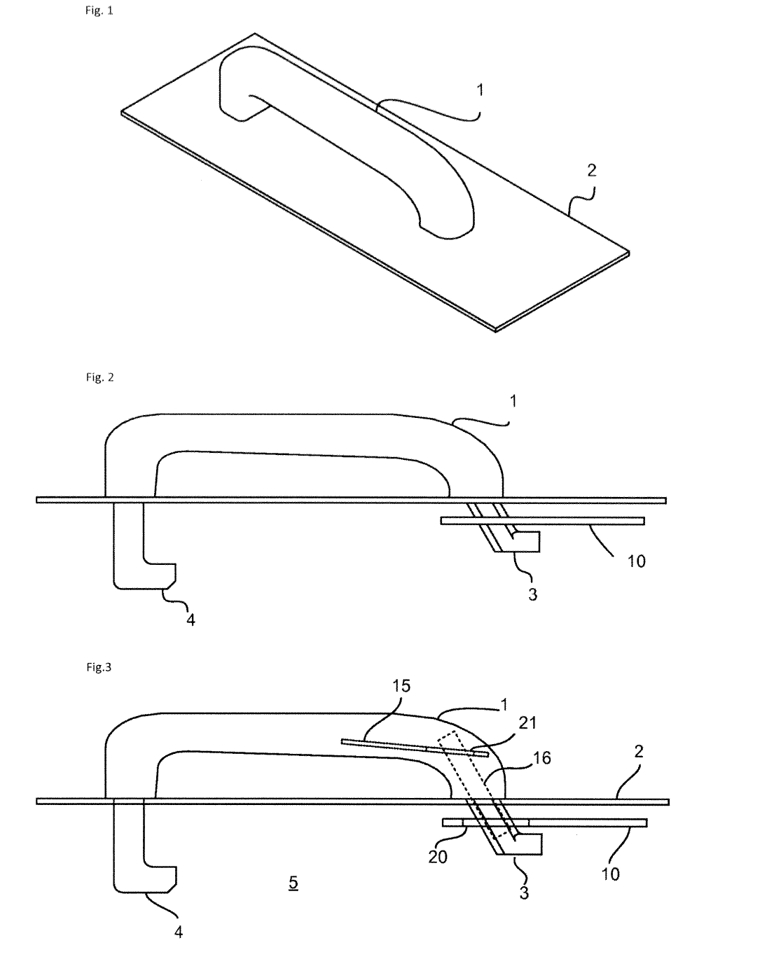

FIG. 1 shows a door handle assembly in accordance with a first design example of the invention in a schematic, perspective exterior view;

FIG. 2 shows a schematic side view of the door handle assembly in accordance with the first design example;

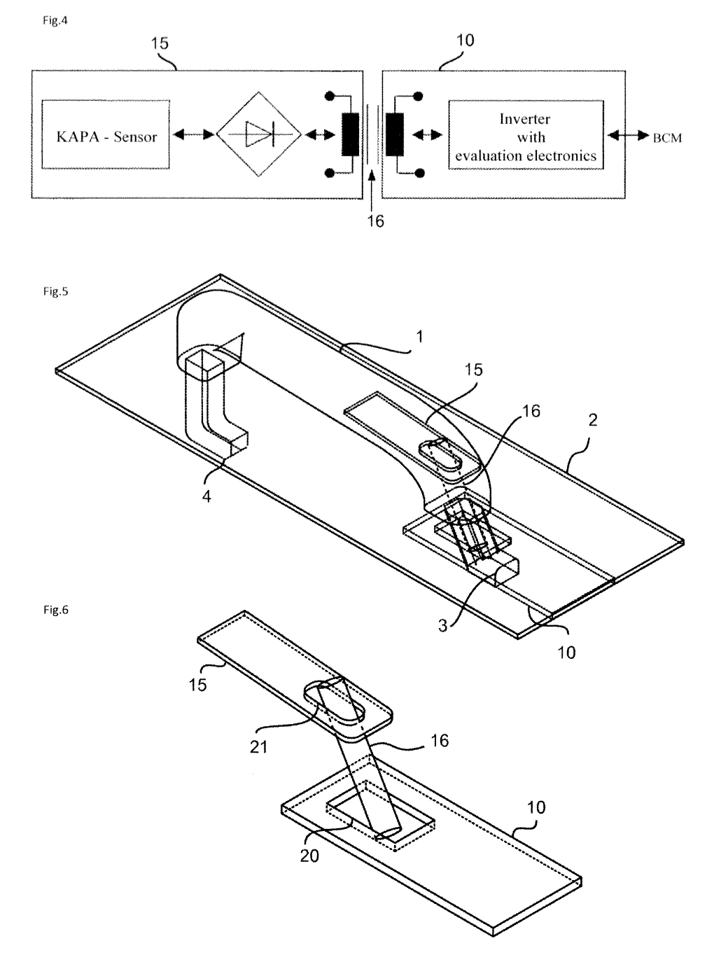

FIG. 3 shows the schematic view from FIG. 2, with the elements located inside the handle visibly represented by broken lines;

FIG. 4 shows a block diagram of the electronic components of the first design example;

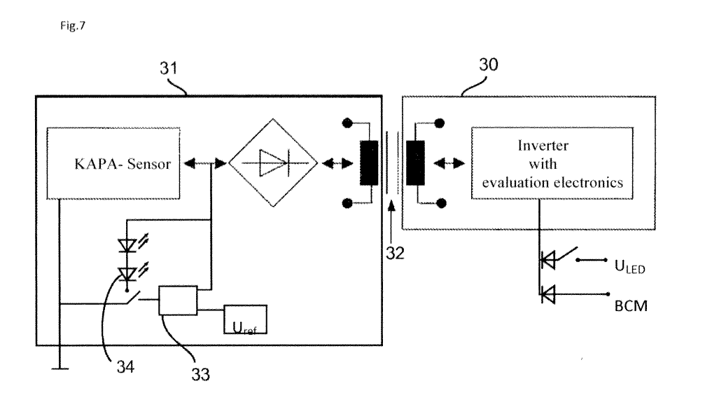

FIG. 5 shows the perspective exterior view from FIG. 1, with hidden elements represented by broken lines;

FIG. 6 shows the components of the circuit board on the handle side and the vehicle side along with the coil core in an enlarged detailed view;

FIG. 7 shows a block diagram of the electronic components of a second design example.

FIG. 1 shows how a door handle with a handle 1 is arranged on the panel 2 of a vehicle door. The door handle 1 must be touched by the user from behind in order to activate the opening, closing or other functions.

As shown in FIG. 2, a front fastener section 3 and also a rear fastener section 4 are arrayed in the handle 1. The fastener sections are connected to the handle 1. The fastener sections 3 and 4 are passed through openings designed in the panel 2 of the door and, when installed, are located on the inner side 5 of the vehicle, whereas the handle is found on the accessible outer side 6 of the vehicle. In the area of the inner door space 5, fastener elements for receiving the fastener sections 3 and 4 are designed in the mount of the handle assembly; the fastener elements, however, are not represented in this schematic view for reasons of clarity. On the inner door side 5 a circuit board 10 is arranged in or on the mount, with an opening being designed in the circuit board 10. The front fastener section 3 of the handle assembly is passed through the opening.

Fastener sections 3 and 4 may serve as fixtures but they may also have activating tasks. For example, a mechanical locking device can be assigned and coupled to the rear fastener section 4, with a locking function activated through the fastener section 4 when the door handle is pulled. On the inner side of the vehicle door 5, for example, the fastener section 3 can be contained in a fastener receptacle in order to pivot the door handle around a pivot point. As shown in FIG. 3, a circuit board 15 is cast in the handle component with a coil core passing through the circuit board or it is injection-molded with synthetic material. The coil core 16 extends into the front fastener section 3. The circuit board 15 essentially extends along the handle 1 of the handle component. The circuit board 10 is situated on the inner side of the door 5 with an interior opening 20 through which fastener section 3 passes along with the coil core 16 located inside the fastener section 3. Coils are designed on circuit boards 15 and 10, each built from conductor paths; the coils surround the opening through which the coil core 16 extends.

Therefore an open magnetic field is designed in the handle, which is depicted in its mounted position in FIG. 3, with a coupling between the coils on the circuit board 10 which surrounds the opening 20, and also the coil on the circuit board 15 which surrounds the opening 21.

By means of this magnetic coupling information about the status of the sensors in handle 1 can be prompted from the vehicle side 5.

FIG. 4 shows a simplified block diagram, depicting the functions and the interaction of the circuit board 10, the coil core 16 and the circuit board 21. For establishing the appropriate connection for the exchange of information the coupling by means of the coil core 16 alone is sufficient; the coil core consists of a suitable material such as a ferrite. Further electronic components, in this case a capacitance sensor as well as a rectifier assembly, are arranged in handle 1. These further components can be directly arrayed on the circuit board 15 or coupled to it in some fashion.

The circuit board 10 is coupled to a control board (BCU) of the vehicle, and an electronic evaluation system may be arranged on the circuit board 10 itself or on any other location on the vehicle side.

FIG. 5 shows the handle assembly in a perspective, partly transparent view in which the position of the elements in respect to each other is made clear.

FIG. 6 depicts in enlarged format the detail of both circuit boards with the coil core 16 that penetrates both circuit boards. The opening in the circuit board 15 is designed in such a way that it directly surrounds the coil core, since no motion is expected on the handle side between coil core 16 and circuit board 15, since both components are injection-molded with synthetic material and fixed in their position. The opening 20, on the other hand, is of a size and shape allowing the fastener section 3 together with the handle to be pivoted in the opening to the intended degree. The depicted arrangement ensures that the magnetic field lines generated on one side of the coil are acted upon by the coil core and its magnetic properties and also penetrate the other corresponding coil. Thus the prompting of the sensors on the handle side can ensue by means of the electrical load, which on the side of the handle 1 is coupled to the coil.

FIG. 7 depicts a block diagram of the electronic components of a second design form of the invention.

A switch component 30 is designed on the vehicle side. The inverter of the switch component can be supplied selectively with voltage U_{ref} provided for the sensor function or an illumination system voltage U_{LED} by means of activation from the vehicle side. The voltage transmitted to the handle side 31 is rectified and compared to the voltage U_{ref} with an electric comparator 33. If the voltage surpasses the voltage provided for the sensor function, the LEDs 34 are activated. In this way a simple illumination selection on the handle side is possible through preset voltage.

Alternatively, the comparator can be dispensed with if the appropriate LEDs are turned on in series. Then the series connection of LEDs can simultaneously assume the switching function, since the LEDs only illuminate and conduct when sufficient voltage is transmitted to the handle side 31.

Numerous variants are possible within the framework of the Invention; for example, a similar arrangement of circuit boards and coil cores can be implemented in another handle section. The essential aspect is for the coil core along with a surrounding coil to be arranged in the handle in such a way that it extends to a component part which can be coupled to a suitable surrounding coil on the vehicle side.

An energy storage device can also be arrayed in the outside component of the handle to enable expanded functions on the handle side. In addition, the coupling in accordance with the invention can also be used in combination with a standard conductive coupling.

1. Door handle assembly for a motor vehicle, wherein a handle component features a handle and at least one fastener section connected to the handle, allowing the fastener section to be coupled to a fastener receptacle arrayed in a door of the motor vehicle,
characterized by
the design of a first conductive coil in the handle component whose winding surrounds a coil core arrayed in the handle component, the coil core extending at least partially in the fastener section of the handle component,
a second conductive coil in the region of the fastener receptacle on the vehicle side, designed in such a way that the coil core arrayed in the handle component extends through the second conductive coil when the fastener section is coupled to the fastener receptacle.

2. Door handle assembly according to claim 1, characterized by the design of the first conductive coil as a conductor path on a circuit board, an opening for the passage of the coil core being designed in the circuit board.

3. Door handle assembly according to claim 1, characterized by the design of a coil core as a ferrite coil core.

4. Door handle assembly according to claim 1, characterized by the handle component having two fastener sections connected to the handle, with the coil core arrayed in at least one of the fastener sections.

5. Door handle assembly according to claim 1, characterized by the encapsulation of the coil core and the first coil winding in the handle component by being injection-molded with a synthetic material.

6. Door handle assembly according to claim 1, characterized by the coupling of a selectable evaluation circuit to the second conductive coil on the vehicle side.

7. Door handle assembly according to claim 6, characterized by the array in the handle component of electronic sensor components that are electronically coupled to the winding of the first coil, so that the evaluation circuit on the vehicle side can identify a condition detected by the sensor components when the coil core penetrates the winding of the first and second coil.

8. Door handle assembly according to claim 7, characterized by a sensory prompting that takes place when a changed electrical load on the part of the components on the handle side is evaluated.

9. Door handle assembly according to claim 1, with the fastener receptacle designed in one piece with a handle mount that is arrayed in the door.

10. Door handle assembly according to claim 1, with an electrical rectifier device being coupled to the first conductive coil.

11. Door handle assembly according to claim 1, with an electrical inverter device being coupled to the second conductive coil.

12. Door handle assembly according to claim 1, characterized by the coupling of at least one LED to the first conductive coil.

13. Door handle assembly according to claim 12, characterized by the coupling of an electrical comparator to the LED, the comparator supplying the LED with voltage when a higher voltage than the specified minimal voltage is induced in the first conductive coil.
